(19) United States
(12) Patent Application Publication
(10) Pub. No.: US 2024/0155184 A1
(43) Pub. Date: May 9, 2024

(54) SYSTEMS AND METHODS FOR MODERATING A MEDIA STREAM

(71) Applicant: Pfizer Inc, New York, NY (US)

(72) Inventors: Bo Huai Victor Loh, Menlo Park, CA (US); Hemal Khatri, Redmond, WA (US)

(21) Appl. No.: 17/211,500

(22) Filed: Mar. 24, 2021

(51) Int. Cl. H04N 21/4402; H04L 29/06; H04N 21/2187; H04N 21/45; H04N 21/845

(52) U.S. Cl. CPC H04N 21/4402; H04L 67/40; H04N 21/2187; H04N 21/4532; H04N 21/8456

(57) ABSTRACT

Systems, methods, and non-transitory computer-readable media can be configured to determine a portion of a media stream to be moderated. A moderated segment of media can be generated based on the portion of the media stream, and an unmoderated segment of media can be generated based on the portion of the media stream. The moderated segment of media or the unmoderated segment of media can be provided based on viewer information associated with a viewer of the media stream.

### FIELD OF THE INVENTION

The present technology relates to the field of digital media streaming. More particularly, the present technology relates to moderating content in a digital media stream.

### BACKGROUND

Today, people often utilize computing devices (or systems) for a wide variety of purposes. For example, users can utilize computing devices to access a social networking system or other type of content or communication platform. The users can utilize the computing devices to interact with one another, share content items, and view content items via the platform. In some instances, a user may utilize the platform to broadcast a live media stream that is accessed by other users.

### SUMMARY

Various embodiments of the present technology can include systems, methods, and non-transitory computer readable media configured to determine a portion of a media stream to be moderated. A moderated segment of media can be generated based on the portion of the media stream, and an unmoderated segment of media can be generated based on the portion of the media stream. The moderated segment of media or the unmoderated segment of media can be provided based on viewer information associated with a viewer of the media stream.

In an embodiment, a procedure call is generated based on the determining the portion of the media stream to be moderated, wherein the procedure call includes timestamps associated with the portion of the media stream to be moderated.

In an embodiment, the procedure call further includes information relating to a policy violation associated with the portion of the media stream to be moderated.

In an embodiment, the providing the moderated segment of media or the unmoderated segment of media is further based on the timestamps associated with the portion of the media stream and the information relating to the policy violation.

In an embodiment, the moderated segment of media includes an altered segment of a first media type and an unaltered segment of a second media type.

In an embodiment, the moderated segment is provided to the viewer. A notification is provided to the viewer that indicates that the media stream is moderated.

In an embodiment, a notification is provided to a streamer associated with the media stream that indicates that the media stream is moderated.

In an embodiment, the moderated segment of media includes at least one of: a muted segment of audio, a silenced segment of audio, a garbled segment of audio, a blanked segment of video, a frozen segment of video, or a blurred segment of video.

In an embodiment, the viewer information includes at least one of: an age, a geographical region, or a membership status associated with the viewer.

In an embodiment, the media stream is broadcasted live to viewers in real time or near real time.

It should be appreciated that many other features, applications, embodiments, and/or variations of the disclosed technology will be apparent from the accompanying drawings and from the following detailed description. Additional and/or alternative implementations of the structures, systems, non-transitory computer readable media, and methods described herein can be employed without departing from the principles of the present technology.

### BRIEF DESCRIPTION OF THE DRAWINGS

FIG. 1 illustrates an example system including a media moderation module, according to an embodiment of the present technology.

FIG. 2 illustrates an example functional block diagram, according to an embodiment of the present technology.

FIG. 3 illustrates an example system, according to an embodiment of the present technology.

FIGS. 4A-4B illustrate example interfaces, according to an embodiment of the present technology.

FIG. 5 illustrates an example method, according to an embodiment of the present technology.

FIG. 6 illustrates a network diagram of an example system including an example social networking system that can be utilized in various scenarios, according to an embodiment of the present technology.

FIG. 7 illustrates an example of a computer system or computing device that can be utilized in various scenarios, according to an embodiment of the present technology.

The figures depict various embodiments of the disclosed technology for purposes of illustration only, wherein the figures use like reference numerals to identify like elements. One skilled in the art will readily recognize from the following discussion that alternative embodiments of the structures and methods illustrated in the figures can be employed without departing from the principles of the present technology described herein.

### DETAILED DESCRIPTION

Today, people often utilize computing devices (or systems) for a wide variety of purposes. For example, users can utilize computing devices to access a social networking system or other type of content or communication platform. The users can utilize the computing devices to interact with one another, share content items, and view content items via the platform. In some instances, a user may utilize the platform to broadcast a live media stream that is accessed by other users.

Under conventional approaches, users can interact with other users through a social networking system or other type of content or communication platform. For example, a user can broadcast a live media stream. The live media stream can be provided to a platform. Other users can access the live media stream via the platform. Under conventional approaches, a live media stream is unmoderated while the live media stream is being broadcast. Various problems can arise during a live media stream. For example, a user can broadcast a live media stream that includes copyrighted content (e.g., audio, video) that is not properly licensed or the user can broadcast content that violates community guidelines. Community guidelines can include, for example, prohibitions against content containing inappropriate language, violent content, or sexual content. Unlicensed content or prohibited content that appears in a live media stream despite copyright laws and community guidelines can negatively impact user experience. In some cases, unlicensed content can create legal risks, such as Digital Millennium Copyright Act (DMCA) violations, for a platform. A conventional approach to address these problems is to completely stop the live media stream altogether, a potentially undue measure that can detract from user experience. Conventional approaches fail to moderate these and other types of improper content in a live media stream. Further, these problems often involve various complexities. For example, users of different demographics can watch live media streams from different geographic regions. Further, different demographics can be associated with different community guidelines. Moreover, different geographic regions can be associated with different community guidelines and copyright restrictions. These complexities are exacerbated as live media streaming becomes more popular and more users in different geographic regions watch live media streams. Conventional approaches arising in the realm of computer technology have been ineffective addressing these problems.

An improved approach rooted in computer technology overcomes the foregoing and other disadvantages associated with conventional approaches specifically arising in the realm of computer technology. In various embodiments, the present technology provides for real-time (or near real-time) moderation of a media stream (e.g., live media stream, live video stream, live audio stream). A user (e.g., streamer) can broadcast a media stream through a media server (e.g., live media server, live video server, live audio server) to viewers. As the media stream is being broadcast, audio and video in the media stream can be analyzed to determine whether the audio or the video violates a policy, such as a copyright restriction or a community guideline. Based on a determination that the audio or the video violates the policy, the media server can generate moderated (e.g., muted, blurred) segments of media and unmoderated (e.g., unmuted, unblurred) segments of media from the media stream. The media server can also record information, such as timestamps corresponding to portions of the audio or the video associated with a policy violation and the policy that was violated. Other users (e.g., viewers) can access the media stream via the media server. The viewers can provide viewer information, such as their geographic location, in order to access the media stream. Based on the viewer information, the viewers can be provided with the moderated segments of media or the unmoderated segments of media. For example, a streamer can broadcast a live video stream of the streamer playing a video game. In this example, the streamer is also playing copyrighted music in the background. The live video stream can be determined to violate copyright restrictions in certain contexts based on the copyrighted music playing in the background. Accordingly, a live video server through which the live video stream is being broadcast can generate muted segments of the live video stream and unmuted segments of the live video stream. In this example, viewers can access the live video server and provide viewer information indicating geographic locations of the viewers. Based on the geographic location, the viewers can be provided with the muted segments or the unmuted segments using the timestamps. For example, one viewer can be in a geographic location where broadcast of the copyrighted music does not violate copyright restrictions (e.g., the music is permitted to be broadcast). This viewer can be provided with the unmuted segments. Another viewer can be in a geographic location where broadcast of the copyrighted music does violate copyright restrictions (e.g., the music is not permitted to be broadcast). This viewer can be provided with the muted segments. More details relating to the present technology are provided below.

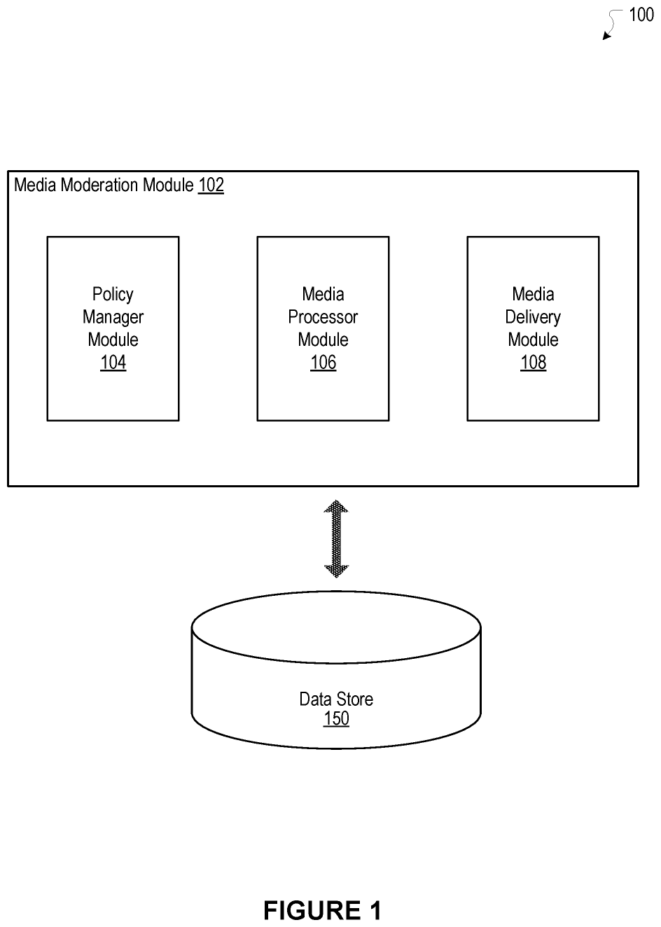

FIG. 1 illustrates an example system 100 including a media moderation module 102, according to an embodiment of the present technology. As shown in the example of FIG. 1, the media moderation module 102 can include a policy manager module 104, a media processor module 106, and a media delivery module 108. In some instances, the example system 100 can include at least one data store 150 in communication with the media moderation module 102. The components (e.g., modules, elements, etc.) shown in this figure and all figures herein are exemplary only, and other implementations may include additional, fewer, integrated, or different components. Some components may not be shown so as not to obscure relevant details. In various embodiments, one or more of the functionalities described in connection with the policy manager module 104, the media processor module 106, and the media delivery module 108 can be implemented in any suitable combinations. While the media moderation module 102 is sometimes herein discussed in connection with a social networking system for purposes of illustration, the media moderation module 102 of the present technology can be used in or for any other type of content or communication platform that can support a media stream, such as an audio streaming platform, video streaming platform, etc. For example, the media moderation module 102 can be implemented in a suitable server system, such as a live video server.

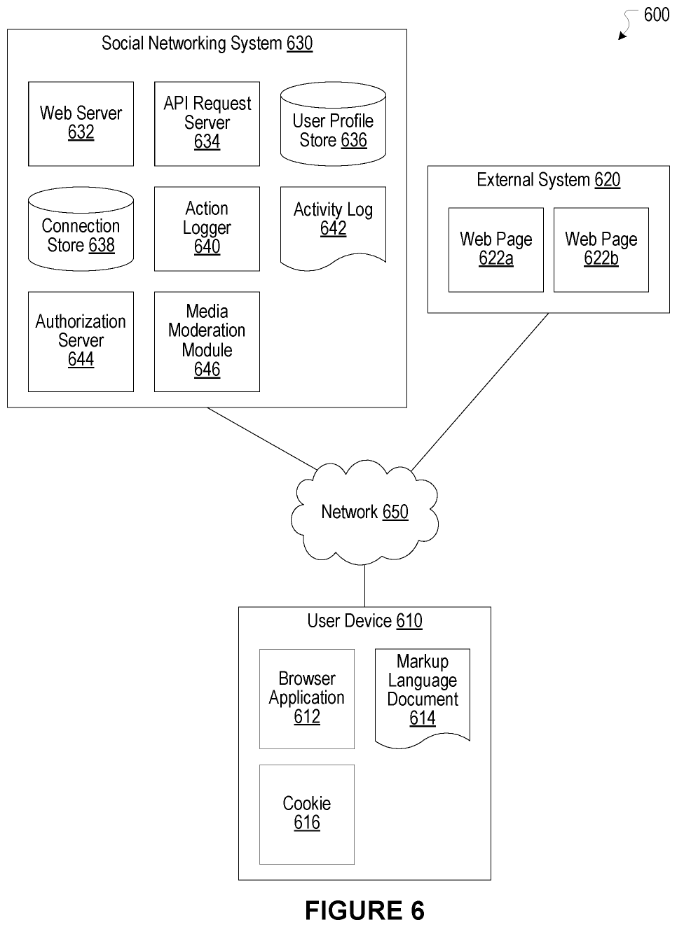

In various embodiments, the media moderation module 102 can be implemented, in part or in whole, as software, hardware, or any combination thereof. In general, a module as discussed herein can be associated with software, hardware, or any combination thereof. In some implementations, one or more functions, tasks, and/or operations of modules can be carried out or performed by software routines, software processes, hardware, and/or any combination thereof. In some instances, the media moderation module 102 can be, in part or in whole, implemented as software running on one or more computing devices or systems, such as on a server system or a client computing device. In some instances, the media moderation module 102 can be, in part or in whole, implemented within or configured to operate in conjunction with or be integrated with a social networking system (or service), such as a social networking system 630 of FIG. 6. Likewise, in some instances, the media moderation module 102 can be, in part or in whole, implemented within or configured to operate in conjunction with or be integrated with a client computing device, such as the user device 610 of FIG. 6. For example, the media moderation module 102 can be implemented as or within a dedicated application (e.g., app), a program, or an applet running on a user computing device or client computing system. The application incorporating or implementing instructions for performing functionality of the media moderation module 102 can be created by a developer. The application can be provided to or maintained in a repository. In some instances, the application can be uploaded or otherwise transmitted over a network (e.g., Internet) to the repository. For example, a computing system (e.g., server) associated with or under control of the developer of the application can provide or transmit the application to the repository. The repository can include, for example, an “app” store in which the application can be maintained for access or download by a user. In response to a command by the user to download the application, the application can be provided or otherwise transmitted over a network from the repository to a computing device associated with the user. For example, a computing system (e.g., server) associated with or under control of an administrator of the repository can cause or permit the application to be transmitted to the computing device of the user so that the user can install and run the application. The developer of the application and the administrator of the repository can be different entities in some cases, but can be the same entity in other cases. It should be understood that many variations are possible.

The media moderation module 102 can be configured to communicate and/or operate with the data store 150, as shown in the example system 100. The data store 150 can be configured to store and maintain various types of data. In some implementations, the data store 150 can store information associated with the social networking system (e.g., the social networking system 630 of FIG. 6). The information associated with the social networking system can include data about users, user identifiers, social connections, social interactions, profile information, demographic information, locations, geo-fenced areas, maps, places, events, pages, groups, posts, communications, content, feeds, account settings, privacy settings, a social graph, and various other types of data. In some embodiments, the data store 150 can store information that is utilized by the media moderation module 102. For example, the data store 150 can store information associated with a media stream. It is contemplated that there can be many variations or other possibilities.

In various embodiments, the policy manager module 104 can determine whether media violates a policy. The media can be from a media stream, such as a live video stream or a live audio stream. The media can be subject to various policies, such as copyright restrictions and community guidelines. Copyright restrictions can apply to, for example, copyrighted audio, such as copyrighted music, and copyrighted video, such as copyrighted movies. Community guidelines can include, for example, audio restrictions, such as restrictions against inappropriate language (e.g., foul language, etc.), and video restrictions, such as restrictions against displaying inappropriate subject matter (e.g., violence, pornography, etc.). In some cases, various managers, such as suitably designed computer or software functionality, can be associated with the various policies. For example, a copyright manager supported by the policy manager module 104 can determine whether audio or video violates copyright restrictions. As another example, an integrity manager supported by the policy manager module 104 can determine whether audio or video violates community guidelines. In some cases, a determination of whether media violates a policy can be based on a third party service. For example, media can be passed through an API to a third party service that returns a determination of whether the media includes copyrighted media and whether broadcast of the media would constitute a copyright violation. Many variations are possible.

The policy manager module 104 can determine whether a live media stream violates a policy based on a real time (or near real time) analysis of the live media stream. Media from the live media stream can be compared with references in a reference database. Based on the comparison, whether the media from the live media stream violates a policy can be determined. In some cases, audio from a live media stream can be compared with references in a reference database based on audio fingerprinting techniques. In general, an audio fingerprint can be a digital representation of an audio signal. An audio fingerprint can be generated from a sample of the audio from the live media stream. The audio fingerprint can be compared with reference audio fingerprints of reference material, such as copyrighted music, to determine whether the audio from the live media stream contains copyrighted music, whether the audio from the live media stream violates copyright restrictions, or whether the audio violates community guidelines. In some cases, video from a live media stream can be compared with references in a reference database based on image recognition techniques. Frames of the video from the live media stream can be compared with reference frames of reference material, such as images of inappropriate subject matter or frames of copyrighted video, to determine whether the video from the live media stream contains inappropriate subject matter and violates community guidelines or contains copyrighted video and violates copyright restrictions. For example, frames of video in a live media stream can contain frames of a copyrighted movie. The frames of video can be determined to contain copyrighted video and violate copyright restrictions In some cases, comparison of media from a live media stream with references in a reference database to determine a policy violation can be based on machine learning techniques. For example, a machine learning model to determine violations of policies can be trained based on training data that includes media and reference material of media that violates a policy. Positive training data can include media that violates a policy and reference material of media corresponding to the violated policy. Negative training data can include media that does not violate a policy. During evaluation, the machine learning model can be applied to media from a live media stream to determine a likelihood (e.g., score) that the media violates a policy. Media that satisfies or exceeds a threshold likelihood can be determined to violate a policy. In some cases, escalation to human reviewers can be utilized to make a decision on whether the media violates policy. Many variations are possible.

Based on a determination that media violates a policy, the policy manager module 104 can record information associated with the media. The information can include, for example, a timestamp of when the media begins to violate the policy and a timestamp of when the media no longer violates the policy. The information also can include, for example, information about the policy that was violated and information about what part of the media (e.g., audio, video) violated the policy. In some cases, information associated with media that violates a policy can be provided to a media processor, such as the media processor module 106. The information can be stored in a log associated with the media. The information can be provided, for example, through an API call, remote procedure call (RPC), or other procedure call or signal. For example, a streamer can broadcast a live video stream and, during the live video stream, the streamer can play copyrighted music in the background. Audio of the live video stream can be determined to violate copyright restrictions. Based on the determination, information about the copyright violation can be stored in a log associated with the live video stream. Further, based on the determination, a first timestamp of when the audio of the copyrighted music started and a second time stamp of when the audio of the copyrighted music stopped can be stored in the log associated with the live video stream. An indication that the audio, and not the video, violates the copyright restriction can also be stored in the log. As further described herein, based on the determination, a signal can be provided to a media processor to generate muted segments of the live video stream.

In various embodiments, the media processor module 106 can generate moderated segments of media and generate unmoderated segments of media. A segment of media can include segments of different types of media, such as audio and video. Segments of media can be moderated based on various techniques corresponding with a type of media to be moderated. In cases where audio is the type of media to be moderated, moderated segments of media can include, for example, muted segments of audio (e.g., audio amplitude is reduced to threshold or imperceptible levels for a duration of a segment), silenced segments of audio (e.g., no audio is provided for a duration of a segment), or garbled segments of audio (e.g., audio is distorted for a duration of a segment). In cases where video is the type of media to be moderated, moderated segments of media can include, for example, blanked segments of video (e.g., no video is provided for a duration of a segment), frozen segments of video (e.g., a video frame is repeated for a duration of a segment), or blurred segments of video (e.g., video is distorted for a duration of a segment). In some cases, moderated segments of media can include various combinations of moderated and unmoderated segments of audio and moderated and unmoderated segments of video. For example, a moderated segment of media to remove copyrighted music can include a muted segment of audio and an unmoderated segment of video. As another example, a moderated segment of media to remove content that violates community guidelines can include a blurred segment of video and a silenced segment of audio. Many variations are possible.

The media processor module 106 can generate a moderated segment of media and an unmoderated segment of media in response to a signal (e.g., API call, RPC). The signal can include, for example, an instruction to begin generating moderated segments of media or a timestamp associated with when a moderated segment of media should start. The signal can also include, for example, information associated with a policy that was violated or a type of media to moderate. In some cases, the type of media to moderate can be determined based on the information associated with the policy that was violated. For example, media that violates community guidelines because of excessive violence can indicate that the type of media warranting moderation is video. The unmoderated segment of media can include media that has not been modified or altered. For example, during a live video stream, a determination can be made that the live video stream includes content that violates, for example, community guidelines for viewers under a specified age. An API call can be generated based on the determination. Based on the API call, moderated segments of media and unmoderated segments of media can be generated from the live video stream. The moderated segments of media can include, for example, blurred segments of video and muted segments of audio. The unmoderated segments of media can include segments of unaltered media from the live video stream. Viewers who access the live video stream can be provided with the moderated segments of media or the unmoderated segments of media based on ages of the viewers.

In some cases, the media processor module 106 can provide notifications to streamers to indicate that content in a media stream violates a policy. The notifications to the streamers can indicate that the media stream is being moderated due to a policy violation. This can allow the streamers to remedy the policy violation. For example, a streamer can broadcast a live video stream and viewers can access the live video stream. In this example, during the live video stream, the streamer can inadvertently include content that violates community guidelines. Based on the violation, moderated segments of media can be generated. The moderated segments of media can be provided to the viewers. A notification can be provided to the streamer indicating that content that violates community guidelines was determined to be included in the live video stream. This provides the streamer an opportunity to remedy the violation as soon as possible and continue streaming without the content that violates community guidelines.

In various embodiments, the media delivery module 108 can provide a media stream based on moderated segments of media and unmoderated segments of media. As described herein, moderated segments of media and unmoderated segments of media can be generated from a media stream in response to a signal that includes timestamps associated with when a policy was violated in the media stream and information associated with the policy that was violated. The moderated segments of media and the unmoderated segments of media can be stored in a data store, such as a distributed memory-caching system (e.g., memcache). The timestamps associated with when the policy was violated and the information associated with the policy that was violated can be stored in a data store, such as a database. Based on viewer information associated with a viewer of the media stream, the timestamps associated with when the policy was violated, and the information associated with the policy that was violated, the moderated segments of media or the unmoderated segments of media can be provided to the viewer. The viewer information can include, for example, an age, a geographical region, a membership status (e.g., paid user, premium user, free user), and other information associated with the viewer. In some cases, the viewer information can be based on a profile associated with the viewer, such as a social network profile of the viewer maintained on a social networking system or a profile of the viewer maintained on a content or communication platform (e.g., media streaming platform). For example, a viewer can access a live video stream via a video streaming platform. During the live video stream, a streamer broadcasting the live video stream can include copyrighted music in the background of the live video stream. Based on a determination that the live video stream includes copyrighted music that constitutes a copyright violation, moderated segments of media and unmoderated segments of media can be generated based on the live video stream. A moderated segment of media can include, for example, a muted segment of audio and an unaltered segment of video. An unmoderated segment of media can include, for example, an unaltered segment of audio and an unaltered segment of video. Timestamps associated with when the copyrighted music is included in the live video stream and information about the copyright restrictions associated with the copyrighted music can be stored. In this example, assume that paid users of the video streaming platform can have access to copyrighted music while free users of the video streaming platform are denied access to copyrighted music. Assume further that the viewer in this example is a paid user of the video streaming platform. Viewer information associated with the viewer can be determined based on a profile of the viewer maintained on the video streaming platform. The viewer information can indicate that the viewer is a paid user. Based on the viewer information, the viewer can be provided with unmoderated segments of media from the live video stream. Assume that another viewer in this example is a free user of the video streaming platform. Viewer information associated with the other viewer can indicate that the other viewer is a free user. Based on the viewer information associated with the other viewer, the timestamps associated with when the copyrighted music is included in the live video stream, and the information about the copyright restrictions, the other viewer can be provided with moderated segments of media when the live video stream includes the copyrighted music. The other viewer can be provided with unmoderated segments of media when the live video stream does not include the copyrighted music.

In some cases, the media delivery module 108 can provide notifications to viewers to indicate that content in a media stream violates a policy. The notifications to the viewers can indicate that the media stream is being moderated due to a policy violation. This can allow the viewers to understand that the moderated media stream is not due to a technical issue. For example, a streamer can broadcast a live video stream and viewers can access the live video stream. In this example, during the live video stream, the streamer can inadvertently include content that violates community guidelines. Based on the violation, moderated segments of media can be generated. The moderated segments of media can be provided to the viewers. Notifications can also be provided to the viewers indicating that the live video stream is being moderated.

In some cases, a live media stream can be recorded so viewers can access the live media stream on demand after the live media stream is completed. Recorded versions of the live media stream can be generated based on moderated segments of media and unmoderated segments of media associated with the live media stream. As described herein, different users can be subject to different policies depending on a variety of considerations, such as ages of the users or geographical regions of the users. The recorded versions of the live media stream can be generated in accordance with the different policies. For example, a live video stream can include copyrighted music played in the background of the live video stream. A video streaming platform can generate recorded versions of the live video stream for later access by viewers. In some regions, the video streaming platform can have licensing rights to include the copyrighted music in recorded live video streams. In other regions, the video streaming platform may not have the licensing rights to include the copyrighted music in the recorded live video streams. In this example, a first recorded live video stream can be generated based on unmoderated segments of media generated from the live video stream. The first recorded live video stream can be provided to viewers in the regions where the video streaming platform has the licensing rights to include the copyrighted music. A second recorded live video stream can be generated based on moderated segments of media generated from the live video stream. The second recorded live video stream can be provided to viewers in the regions where the video streaming platform does not have the licensing rights to include the copyrighted music. Many variations are possible.

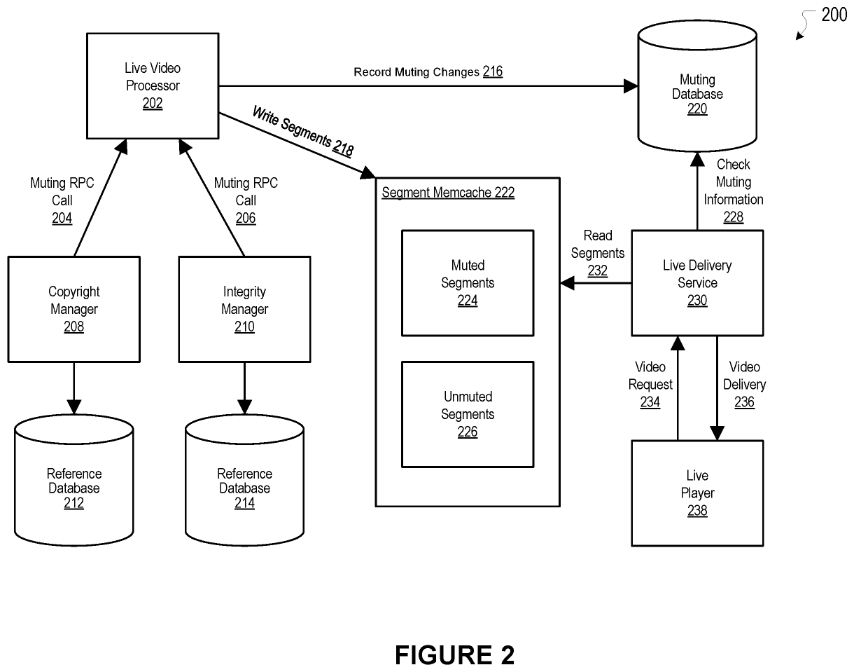

FIG. 2 illustrates an example system 200, according to an embodiment of the present technology. The example system 200 illustrates examples of a live video processor 202, copyright manager 208, integrity manager 210, reference database 212, reference database 214, muting database 220, segment memcache 222, and live delivery service 230 that can implement some or all of the functionality of the media moderation module 102 of FIG. 1. It should be understood that there can be additional, fewer, or alternative steps performed in similar or alternative orders, or in parallel, based on the various features and embodiments discussed herein unless otherwise stated.

In the example system 200, the live video processor 202 can receive and process a live video stream broadcasted by a streamer. As the streamer broadcasts the live video stream, the live video stream can be analyzed by the copyright manager 208 to determine whether content in the live video stream includes copyrighted content. The copyright manager 208 can determine whether the content in the live video stream includes copyrighted content based on reference material in a reference database 212. For example, the copyright manager 208 can identify copyrighted content in the live video stream by comparing audio fingerprints of audio in the live video stream with audio fingerprints of reference material in the reference database 212. The copyright manager 208 can identify copyrighted content in the live video stream by comparing frames of video in the live video stream with reference frames of reference material in the reference database 212. In response to a determination that the live video stream includes copyrighted content associated with a copyright violation, the copyright manager 208 can send a muting RPC call 204 to the live video processor 202. The muting RPC call 204 can instruct the live video processor 202 to generate muted segments of the live video stream and include, for example, timestamps associated with when the copyrighted content is included in the live video stream. The live video stream can also be analyzed by the integrity manager 210 to determine whether content in the live video stream includes content that violates community guidelines. The integrity manager 210 can determine whether the content in the live video stream violates community guidelines based on reference material in a reference database 214. For example, the integrity manager 210 can identify content that violates community guidelines by comparing patterns detected in the live video stream with the reference material in the reference database 214. In response to a determination that the live video stream includes content that violates community guidelines, the integrity manager 210 can send a muting RPC call 206 to the live video processor 202. The muting RPC call 206 can instruct the live video processor 202 to generate muted segments of the live video stream and include, for example, timestamps associated with when the content that violates community guidelines is included in the live video stream. In response to the muting RPC call 204 or the muting RPC call 206, the live video processor 202 can record muting changes 216 in a muting database 220. The muting database 220 can include the information from the muting RPC call 204 or the muting RPC call 206. The information can include, for example, the timestamps included in the muting RPC call 204 or the muting RPC call 206. The live video processor 202, in response to the muting RPC call 204 or the muting RPC call 206, can write segments 218 to a segment memcache 222. The live video processor 202 can write muted segments 224 and unmuted segments 226. The muted segments 224 can include video segments of the live video stream with segments of muted audio. The unmuted segments 226 can include video segments of the live video stream with segments of unmuted audio. In the example system 200, a live player 238 of a computing system associated with a viewer can make a video request 234 to the live delivery service 230. The video request 234 can include viewer information of the viewer associated with the live player 238. The live delivery service 230 can check muting information 228 in the muting database 220. The muting information 228 can include, for example, timestamps of the live video stream that includes copyrighted content or content that violates community guidelines. Based on the muting information in the muting database 220 and the viewer information, the live delivery service 230 can read segments 232 from the segment memcache 222. The live delivery service 230 determines which segments to read based on the muting information and the viewer information. The live delivery service 230 provides video delivery 236 to the live player 238 based on the muted segments 224 or the unmuted segments 226, depending on the muting information and the viewer information. In this way, the live delivery service 230 delivers the live video stream to each viewer in a manner that is not violative of applicable policies. In some cases, the video delivery 236 involves providing a manifest file that includes an index of video segments that constitute the live video stream. The index of video segments in the manifest file can identify the muted segments 224 or the unmuted segments 226 in accordance with the appropriate video stream for the viewer based on the muting information and the viewer information. All examples herein are provided for illustrative purposes, and there can be many variations and other possibilities.

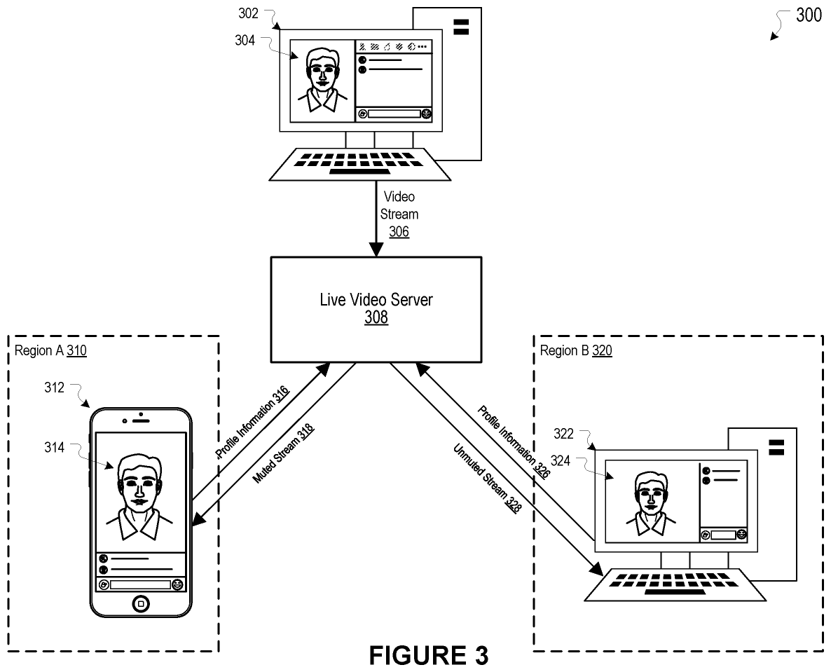

FIG. 3 illustrates an example system 300, according to an embodiment of the present technology. The example system 300 illustrates a live video stream that can be facilitated by the media moderation module 102 of FIG. 1. It should be understood that there can be additional, fewer, or alternative steps performed in similar or alternative orders, or in parallel, based on the various features and embodiments discussed herein unless otherwise stated.

In the example system 300, a streaming device 302 can broadcast a video stream 306 through a live video server 308. The streaming device 302 can include a streaming interface 304 that allows a streamer associated with the streaming device 302 to control the video stream 306. In the example system 300, a first viewer device 312 and a second viewer device 322 can request the video stream 306 from the live video server 308. The first viewer device 312 can be in region A 310. The second viewer device 322 can be in region B 320. In this example, region A 310 and region B 320 can be, for example, different geographic regions, demographic groups, functional categories, or other classification types. In this example, the video stream 306 can include content that violates a policy associated with region A 310. The content does not violate a policy associated with region B 320. The live video server 308 can generate a muted stream 318 based on the video stream 306 that includes muted segments of the video stream 306. The live video server 308 can also generate an unmuted stream 328 based on the video stream 306 that includes unmuted segments of the video stream 306. The live video server can determine profile information 316 provided by the first viewer device 312, for example, when the first viewer device 312 requests manifest information from the live video server 308 for the video stream 306. Based on the profile information 316, the live video server 308 can determine that the first viewer device 312 is in region A 310. Based on the determination that the first viewer device 312 is in region A 310, the live video server 308 can provide the muted stream 318 to the first viewer device 312 to avoid violation of the policy associated with region A 310. The muted stream 318 is accordingly displayed on the first viewer device 312. The live video server can determine profile information 326 provided by the second viewer device 322, for example, when the second viewer device 322 requests manifest information from the live video server 308 for the video stream 306. Based on the profile information 326, the live video server 308 can determine that the second viewer device 322 is in region B 320. Based on the determination that the second viewer device 322 is in region B 320, the live video server 308 can provide the unmuted stream 328 to the second viewer device 322. The unmuted stream 328 is accordingly displayed on the second viewer device 322. All examples herein are provided for illustrative purposes, and there can be many variations and other possibilities.

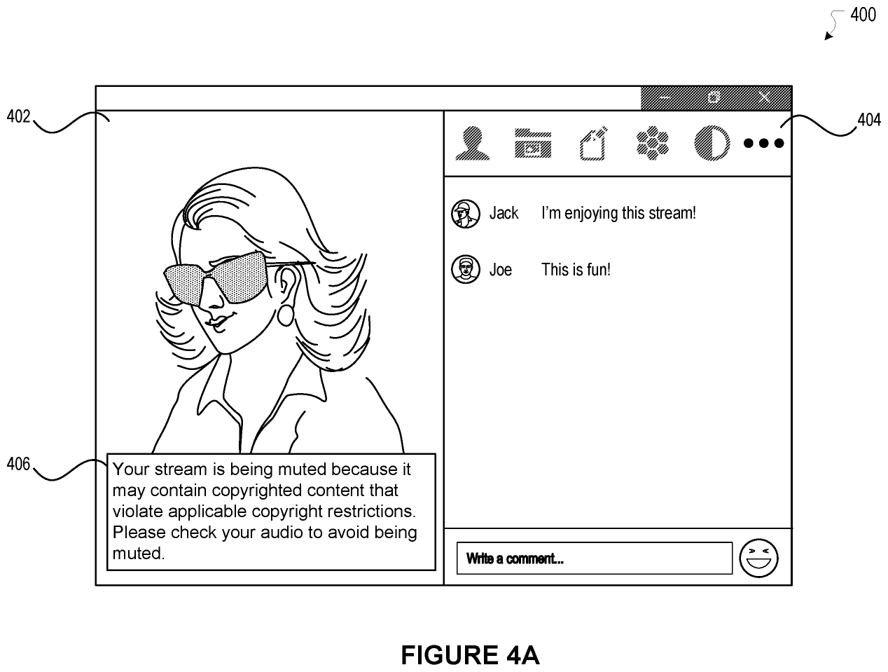

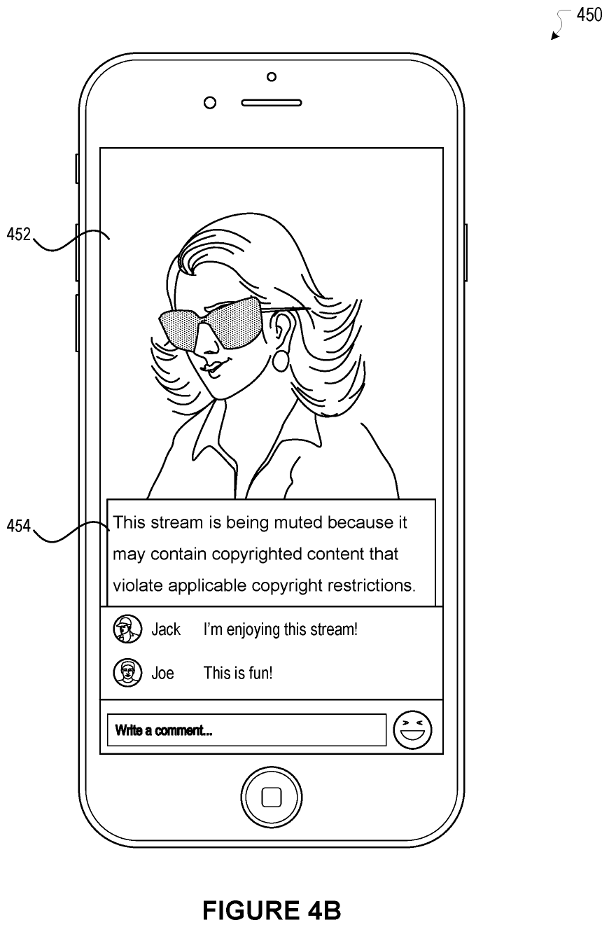

FIGS. 4A-4B illustrate example interfaces generated by computing devices associated with a media stream, according to an embodiment of the present technology. The example interfaces can be associated with one or more functionalities performed by the media moderation module 102 of FIG. 1. It should be understood that there can be additional, fewer, or alternative steps performed in similar or alternative orders, or in parallel, based on the various features and embodiments discussed herein unless otherwise stated.

FIG. 4A illustrates an example interface 400, according to an embodiment of the present technology. The example interface 400 displays an example streamer interface presented through a computing device associated with a streamer that is broadcasting a media stream 402. The example interface 400 displays the media stream 402. The example interface 400 also displays various controls 404 that the streamer can use to control the media stream 402. In this example, a determination has been made that the media stream 402 includes copyrighted content that violates an applicable copyright restriction. A notification 406 is provided to the streamer via the example interface 400 indicating that the media stream 402 has been muted due to the media stream 402 containing copyrighted content that violates the copyright restriction. All examples herein are provided for illustrative purposes, and there can be many variations and other possibilities.

FIG. 4B illustrates an example interface 450, according to an embodiment of the present technology. The example interface 450 displays an example viewer interface presented through a computing device associated with a viewer that is accessing a media stream 452. The example interface 450 displays the media stream 452. The example interface 450 also displays a notification 454. The notification 454 indicates that the media stream 452 has been muted due to the media stream 452 containing copyrighted content that violates an applicable copyright restriction. The notification 454 can be provided to the viewer via the example interface 450 based on a determination that the media stream 452 includes copyrighted content that violates the copyright restriction. All examples herein are provided for illustrative purposes, and there can be many variations and other possibilities.

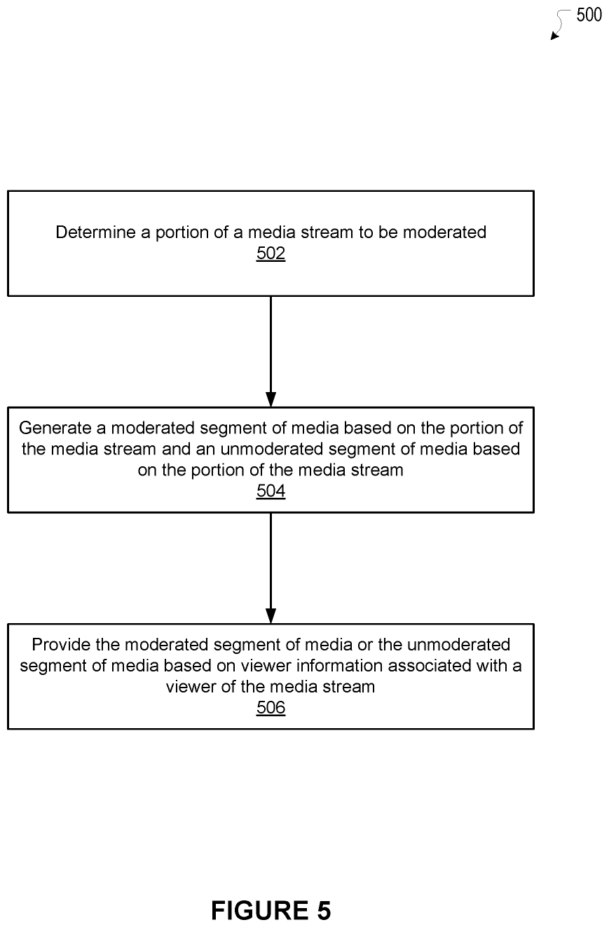

FIG. 5 illustrates an example method 500, according to an embodiment of the present technology. It should be understood that there can be additional, fewer, or alternative steps performed in similar or alternative orders, or in parallel, based on the various features and embodiments discussed herein unless otherwise stated. At block 502, the example method 500 determines a portion of a media stream to be moderated. At block 504, the example method 500 generates a moderated segment of media based on the portion of the media stream and an unmoderated segment of media based on the portion of the media stream. At block 506, the example method 500 provides the moderated segment of media or the unmoderated segment of media based on viewer information associated with a viewer of the media stream.

It is contemplated that there can be many other uses, applications, and/or variations associated with the various embodiments of the present technology. For example, in some cases, a user can choose whether or not to opt-in to utilize the present technology. The present technology can also ensure that various privacy settings and preferences are maintained and can prevent private information from being divulged. In another example, various embodiments of the present technology can learn, improve, and/or be refined over time.

### Social Networking System— Example Implementation

FIG. 6 illustrates a network diagram of an example system 600 that can be utilized in various scenarios, according to an embodiment of the present technology. The system 600 includes one or more user devices 610, one or more external systems 620, a social networking system (or service) 630, and a network 650. In an embodiment, the social networking service, provider, and/or system discussed in connection with the embodiments described above may be implemented as the social networking system 630. For purposes of illustration, the embodiment of the system 600, shown by FIG. 6, includes a single external system 620 and a single user device 610. However, in other embodiments, the system 600 may include more user devices 610 and/or more external systems 620. In certain embodiments, the social networking system 630 is operated by a social network provider, whereas the external systems 620 are separate from the social networking system 630 in that they may be operated by different entities. In various embodiments, however, the social networking system 630 and the external systems 620 operate in conjunction to provide social networking services to users (or members) of the social networking system 630. In this sense, the social networking system 630 provides a platform or backbone, which other systems, such as external systems 620, may use to provide social networking services and functionalities to users across the Internet.

The user device 610 comprises one or more computing devices that can receive input from a user and transmit and receive data via the network 650. In one embodiment, the user device 610 is a conventional computer system executing, for example, a Microsoft Windows compatible operating system (OS), Apple OS X, and/or a Linux distribution. In another embodiment, the user device 610 can be a device having computer functionality, such as a smart-phone, a tablet, a personal digital assistant (PDA), a mobile telephone, etc. The user device 610 is configured to communicate via the network 650. The user device 610 can execute an application, for example, a browser application that allows a user of the user device 610 to interact with the social networking system 630. In another embodiment, the user device 610 interacts with the social networking system 630 through an application programming interface (API) provided by the native operating system of the user device 610, such as iOS and ANDROID. The user device 610 is configured to communicate with the external system 620 and the social networking system 630 via the network 650, which may comprise any combination of local area and/or wide area networks, using wired and/or wireless communication systems.

In one embodiment, the network 650 uses standard communications technologies and protocols. Thus, the network 650 can include links using technologies such as Ethernet, 802.11, worldwide interoperability for microwave access (WiMAX), 3G, 4G, CDMA, GSM, LTE, digital subscriber line (DSL), etc. Similarly, the networking protocols used on the network 650 can include multiprotocol label switching (MPLS), transmission control protocol/Internet protocol (TCP/IP), User Datagram Protocol (UDP), hypertext transport protocol (HTTP), simple mail transfer protocol (SMTP), file transfer protocol (FTP), and the like. The data exchanged over the network 650 can be represented using technologies and/or formats including hypertext markup language (HTML) and extensible markup language (XML). In addition, all or some links can be encrypted using conventional encryption technologies such as secure sockets layer (SSL), transport layer security (TLS), and Internet Protocol security (IPsec).

In one embodiment, the user device 610 may display content from the external system 620 and/or from the social networking system 630 by processing a markup language document 614 received from the external system 620 and from the social networking system 630 using a browser application 612. The markup language document 614 identifies content and one or more instructions describing formatting or presentation of the content. By executing the instructions included in the markup language document 614, the browser application 612 displays the identified content using the format or presentation described by the markup language document 614. For example, the markup language document 614 includes instructions for generating and displaying a web page having multiple frames that include text and/or image data retrieved from the external system 620 and the social networking system 630. In various embodiments, the markup language document 614 comprises a data file including extensible markup language (XML) data, extensible hypertext markup language (XHTML) data, or other markup language data. Additionally, the markup language document 614 may include JavaScript Object Notation (JSON) data, JSON with padding (JSONP), and JavaScript data to facilitate data-interchange between the external system 620 and the user device 610. The browser application 612 on the user device 610 may use a JavaScript compiler to decode the markup language document 614.

The markup language document 614 may also include, or link to, applications or application frameworks such as FLASH™ or Unity™ applications, the SilverLight™ application framework, etc.

In one embodiment, the user device 610 also includes one or more cookies 616 including data indicating whether a user of the user device 610 is logged into the social networking system 630, which may enable modification of the data communicated from the social networking system 630 to the user device 610.

The external system 620 includes one or more web servers that include one or more web pages 622a, 622b, which are communicated to the user device 610 using the network 650. The external system 620 is separate from the social networking system 630. For example, the external system 620 is associated with a first domain, while the social networking system 630 is associated with a separate social networking domain. Web pages 622a, 622b, included in the external system 620, comprise markup language documents 614 identifying content and including instructions specifying formatting or presentation of the identified content.

The social networking system 630 includes one or more computing devices for a social network, including a plurality of users, and providing users of the social network with the ability to communicate and interact with other users of the social network. In some instances, the social network can be represented by a graph, i.e., a data structure including edges and nodes. Other data structures can also be used to represent the social network, including but not limited to databases, objects, classes, meta elements, files, or any other data structure. The social networking system 630 may be administered, managed, or controlled by an operator. The operator of the social networking system 630 may be a human being, an automated application, or a series of applications for managing content, regulating policies, and collecting usage metrics within the social networking system 630. Any type of operator may be used.

Users may join the social networking system 630 and then add connections to any number of other users of the social networking system 630 to whom they desire to be connected. As used herein, the term “friend” refers to any other user of the social networking system 630 to whom a user has formed a connection, association, or relationship via the social networking system 630. For example, in an embodiment, if users in the social networking system 630 are represented as nodes in the social graph, the term “friend” can refer to an edge formed between and directly connecting two user nodes.

Connections may be added explicitly by a user or may be automatically created by the social networking system 630 based on common characteristics of the users (e.g., users who are alumni of the same educational institution). For example, a first user specifically selects a particular other user to be a friend. Connections in the social networking system 630 are usually in both directions, but need not be, so the terms “user” and “friend” depend on the frame of reference. Connections between users of the social networking system 630 are usually bilateral (“two-way”), or “mutual,” but connections may also be unilateral, or “one-way.” For example, if Bob and Joe are both users of the social networking system 630 and connected to each other, Bob and Joe are each other's connections. If, on the other hand, Bob wishes to connect to Joe to view data communicated to the social networking system 630 by Joe, but Joe does not wish to form a mutual connection, a unilateral connection may be established. The connection between users may be a direct connection; however, some embodiments of the social networking system 630 allow the connection to be indirect via one or more levels of connections or degrees of separation.

In addition to establishing and maintaining connections between users and allowing interactions between users, the social networking system 630 provides users with the ability to take actions on various types of items supported by the social networking system 630. These items may include groups or networks (i.e., social networks of people, entities, and concepts) to which users of the social networking system 630 may belong, events or calendar entries in which a user might be interested, computer-based applications that a user may use via the social networking system 630, transactions that allow users to buy or sell items via services provided by or through the social networking system 630, and interactions with advertisements that a user may perform on or off the social networking system 630. These are just a few examples of the items upon which a user may act on the social networking system 630, and many others are possible. A user may interact with anything that is capable of being represented in the social networking system 630 or in the external system 620, separate from the social networking system 630, or coupled to the social networking system 630 via the network 650.

The social networking system 630 is also capable of linking a variety of entities. For example, the social networking system 630 enables users to interact with each other as well as external systems 620 or other entities through an API, a web service, or other communication channels. The social networking system 630 generates and maintains the “social graph” comprising a plurality of nodes interconnected by a plurality of edges. Each node in the social graph may represent an entity that can act on another node and/or that can be acted on by another node. The social graph may include various types of nodes. Examples of types of nodes include users, non-person entities, content items, web pages, groups, activities, messages, concepts, and any other things that can be represented by an object in the social networking system 630. An edge between two nodes in the social graph may represent a particular kind of connection, or association, between the two nodes, which may result from node relationships or from an action that was performed by one of the nodes on the other node. In some cases, the edges between nodes can be weighted. The weight of an edge can represent an attribute associated with the edge, such as a strength of the connection or association between nodes. Different types of edges can be provided with different weights. For example, an edge created when one user “likes” another user may be given one weight, while an edge created when a user befriends another user may be given a different weight.

As an example, when a first user identifies a second user as a friend, an edge in the social graph is generated connecting a node representing the first user and a second node representing the second user. As various nodes relate or interact with each other, the social networking system 630 modifies edges connecting the various nodes to reflect the relationships and interactions.

The social networking system 630 also includes user-generated content, which enhances a user's interactions with the social networking system 630. User-generated content may include anything a user can add, upload, send, or “post” to the social networking system 630. For example, a user communicates posts to the social networking system 630 from a user device 610. Posts may include data such as status updates or other textual data, location information, images such as photos, videos, links, music or other similar data and/or media. Content may also be added to the social networking system 630 by a third party. Content “items” are represented as objects in the social networking system 630. In this way, users of the social networking system 630 are encouraged to communicate with each other by posting text and content items of various types of media through various communication channels. Such communication increases the interaction of users with each other and increases the frequency with which users interact with the social networking system 630.

The social networking system 630 includes a web server 632, an API request server 634, a user profile store 636, a connection store 638, an action logger 640, an activity log 642, and an authorization server 644. In an embodiment of the invention, the social networking system 630 may include additional, fewer, or different components for various applications. Other components, such as network interfaces, security mechanisms, load balancers, failover servers, management and network operations consoles, and the like are not shown so as to not obscure the details of the system.

The user profile store 636 maintains information about user accounts, including biographic, demographic, and other types of descriptive information, such as work experience, educational history, hobbies or preferences, location, and the like that has been declared by users or inferred by the social networking system 630. This information is stored in the user profile store 636 such that each user is uniquely identified. The social networking system 630 also stores data describing one or more connections between different users in the connection store 638. The connection information may indicate users who have similar or common work experience, group memberships, hobbies, or educational history. Additionally, the social networking system 630 includes user-defined connections between different users, allowing users to specify their relationships with other users. For example, user-defined connections allow users to generate relationships with other users that parallel the users' real-life relationships, such as friends, co-workers, partners, and so forth. Users may select from predefined types of connections, or define their own connection types as needed. Connections with other nodes in the social networking system 630, such as non-person entities, buckets, cluster centers, images, interests, pages, external systems, concepts, and the like are also stored in the connection store 638.

The social networking system 630 maintains data about objects with which a user may interact. To maintain this data, the user profile store 636 and the connection store 638 store instances of the corresponding type of objects maintained by the social networking system 630. Each object type has information fields that are suitable for storing information appropriate to the type of object. For example, the user profile store 636 contains data structures with fields suitable for describing a user's account and information related to a user's account. When a new object of a particular type is created, the social networking system 630 initializes a new data structure of the corresponding type, assigns a unique object identifier to it, and begins to add data to the object as needed. This might occur, for example, when a user becomes a user of the social networking system 630, the social networking system 630 generates a new instance of a user profile in the user profile store 636, assigns a unique identifier to the user account, and begins to populate the fields of the user account with information provided by the user.

The connection store 638 includes data structures suitable for describing a user's connections to other users, connections to external systems 620 or connections to other entities. The connection store 638 may also associate a connection type with a user's connections, which may be used in conjunction with the user's privacy setting to regulate access to information about the user. In an embodiment of the invention, the user profile store 636 and the connection store 638 may be implemented as a federated database.

Data stored in the connection store 638, the user profile store 636, and the activity log 642 enables the social networking system 630 to generate the social graph that uses nodes to identify various objects and edges connecting nodes to identify relationships between different objects. For example, if a first user establishes a connection with a second user in the social networking system 630, user accounts of the first user and the second user from the user profile store 636 may act as nodes in the social graph. The connection between the first user and the second user stored by the connection store 638 is an edge between the nodes associated with the first user and the second user. Continuing this example, the second user may then send the first user a message within the social networking system 630. The action of sending the message, which may be stored, is another edge between the two nodes in the social graph representing the first user and the second user. Additionally, the message itself may be identified and included in the social graph as another node connected to the nodes representing the first user and the second user.

In another example, a first user may tag a second user in an image that is maintained by the social networking system 630 (or, alternatively, in an image maintained by another system outside of the social networking system 630). The image may itself be represented as a node in the social networking system 630. This tagging action may create edges between the first user and the second user as well as create an edge between each of the users and the image, which is also a node in the social graph. In yet another example, if a user confirms attending an event, the user and the event are nodes obtained from the user profile store 636, where the attendance of the event is an edge between the nodes that may be retrieved from the activity log 642. By generating and maintaining the social graph, the social networking system 630 includes data describing many different types of objects and the interactions and connections among those objects, providing a rich source of socially relevant information.

The web server 632 links the social networking system 630 to one or more user devices 610 and/or one or more external systems 620 via the network 650. The web server 632 serves web pages, as well as other web-related content, such as Java, JavaScript, Flash, XML, and so forth. The web server 632 may include a mail server or other messaging functionality for receiving and routing messages between the social networking system 630 and one or more user devices 610. The messages can be instant messages, queued messages (e.g., email), text and SMS messages, or any other suitable messaging format.

The API request server 634 allows one or more external systems 620 and user devices 610 to call access information from the social networking system 630 by calling one or more API functions. The API request server 634 may also allow external systems 620 to send information to the social networking system 630 by calling APIs. The external system 620, in one embodiment, sends an API request to the social networking system 630 via the network 650, and the API request server 634 receives the API request. The API request server 634 processes the request by calling an API associated with the API request to generate an appropriate response, which the API request server 634 communicates to the external system 620 via the network 650. For example, responsive to an API request, the API request server 634 collects data associated with a user, such as the user's connections that have logged into the external system 620, and communicates the collected data to the external system 620. In another embodiment, the user device 610 communicates with the social networking system 630 via APIs in the same manner as external systems 620.

The action logger 640 is capable of receiving communications from the web server 632 about user actions on and/or off the social networking system 630. The action logger 640 populates the activity log 642 with information about user actions, enabling the social networking system 630 to discover various actions taken by its users within the social networking system 630 and outside of the social networking system 630. Any action that a particular user takes with respect to another node on the social networking system 630 may be associated with each user's account, through information maintained in the activity log 642 or in a similar database or other data repository. Examples of actions taken by a user within the social networking system 630 that are identified and stored may include, for example, adding a connection to another user, sending a message to another user, reading a message from another user, viewing content associated with another user, attending an event posted by another user, posting an image, attempting to post an image, or other actions interacting with another user or another object. When a user takes an action within the social networking system 630, the action is recorded in the activity log 642. In one embodiment, the social networking system 630 maintains the activity log 642 as a database of entries. When an action is taken within the social networking system 630, an entry for the action is added to the activity log 642. The activity log 642 may be referred to as an action log.

Additionally, user actions may be associated with concepts and actions that occur within an entity outside of the social networking system 630, such as an external system 620 that is separate from the social networking system 630. For example, the action logger 640 may receive data describing a user's interaction with an external system 620 from the web server 632. In this example, the external system 620 reports a user's interaction according to structured actions and objects in the social graph.

Other examples of actions where a user interacts with an external system 620 include a user expressing an interest in an external system 620 or another entity, a user posting a comment to the social networking system 630 that discusses an external system 620 or a web page 622a within the external system 620, a user posting to the social networking system 630 a Uniform Resource Locator (URL) or other identifier associated with an external system 620, a user attending an event associated with an external system 620, or any other action by a user that is related to an external system 620. Thus, the activity log 642 may include actions describing interactions between a user of the social networking system 630 and an external system 620 that is separate from the social networking system 630.

The authorization server 644 enforces one or more privacy settings of the users of the social networking system 630. A privacy setting of a user determines how particular information associated with a user can be shared. The privacy setting comprises the specification of particular information associated with a user and the specification of the entity or entities with whom the information can be shared. Examples of entities with which information can be shared may include other users, applications, external systems 620, or any entity that can potentially access the information. The information that can be shared by a user comprises user account information, such as profile photos, phone numbers associated with the user, user's connections, actions taken by the user such as adding a connection, changing user profile information, and the like.

The privacy setting specification may be provided at different levels of granularity. For example, the privacy setting may identify specific information to be shared with other users; the privacy setting identifies a work phone number or a specific set of related information, such as, personal information including profile photo, home phone number, and status. Alternatively, the privacy setting may apply to all the information associated with the user. The specification of the set of entities that can access particular information can also be specified at various levels of granularity. Various sets of entities with which information can be shared may include, for example, all friends of the user, all friends of friends, all applications, or all external systems 620. One embodiment allows the specification of the set of entities to comprise an enumeration of entities. For example, the user may provide a list of external systems 620 that are allowed to access certain information. Another embodiment allows the specification to comprise a set of entities along with exceptions that are not allowed to access the information. For example, a user may allow all external systems 620 to access the user's work information, but specify a list of external systems 620 that are not allowed to access the work information. Certain embodiments call the list of exceptions that are not allowed to access certain information a “block list”. External systems 620 belonging to a block list specified by a user are blocked from accessing the information specified in the privacy setting. Various combinations of granularity of specification of information, and granularity of specification of entities, with which information is shared are possible. For example, all personal information may be shared with friends whereas all work information may be shared with friends of friends.

The authorization server 644 contains logic to determine if certain information associated with a user can be accessed by a user's friends, external systems 620, and/or other applications and entities. The external system 620 may need authorization from the authorization server 644 to access the user's more private and sensitive information, such as the user's work phone number. Based on the user's privacy settings, the authorization server 644 determines if another user, the external system 620, an application, or another entity is allowed to access information associated with the user, including information about actions taken by the user.

In some embodiments, the social networking system 630 can include a media moderation module 646. The media moderation module 646 can be implemented with the media moderation module 102, as discussed in more detail herein. In various embodiments, some or all functionality of the media moderation module 102 can be additionally or alternatively implemented by the user device 610. It should be appreciated that there can be many variations or other possibilities.

### Hardware Implementation

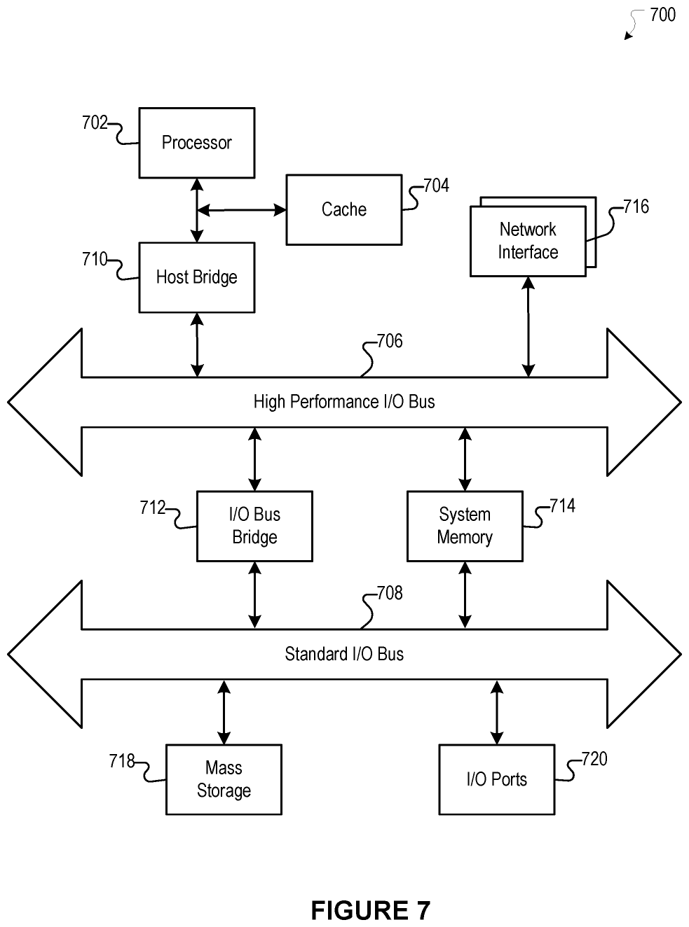

The foregoing processes and features can be implemented by a wide variety of machine and computer system architectures and in a wide variety of network and computing environments. FIG. 7 illustrates an example of a computer system 700 that may be used to implement one or more of the embodiments described herein according to an embodiment of the invention. The computer system 700 includes sets of instructions for causing the computer system 700 to perform the processes and features discussed herein. The computer system 700 may be connected (e.g., networked) to other machines. In a networked deployment, the computer system 700 may operate in the capacity of a server machine or a client machine in a client-server network environment, or as a peer machine in a peer-to-peer (or distributed) network environment. In an embodiment of the invention, the computer system 700 may be the social networking system 630, the user device 610, and the external system 620, or a component thereof. In an embodiment of the invention, the computer system 700 may be one server among many that constitutes all or part of the social networking system 630.

The computer system 700 includes a processor 702, a cache 704, and one or more executable modules and drivers, stored on a computer-readable medium, directed to the processes and features described herein. Additionally, the computer system 700 includes a high performance input/output (I/O) bus 706 and a standard I/O bus 708. A host bridge 710 couples processor 702 to high performance I/O bus 706, whereas I/O bus bridge 712 couples the two buses 706 and 708 to each other. A system memory 714 and one or more network interfaces 716 couple to high performance I/O bus 706. The computer system 700 may further include video memory and a display device coupled to the video memory (not shown). Mass storage 718 and I/O ports 720 couple to the standard I/O bus 708. The computer system 700 may optionally include a keyboard and pointing device, a display device, or other input/output devices (not shown) coupled to the standard I/O bus 708. Collectively, these elements are intended to represent a broad category of computer hardware systems, including but not limited to computer systems based on the x86-compatible processors manufactured by Intel Corporation of Santa Clara, California, and the x86-compatible processors manufactured by Advanced Micro Devices (AMD), Inc., of Sunnyvale, California, as well as any other suitable processor.

An operating system manages and controls the operation of the computer system 700, including the input and output of data to and from software applications (not shown). The operating system provides an interface between the software applications being executed on the system and the hardware components of the system. Any suitable operating system may be used, such as the LINUX Operating System, the Apple Macintosh Operating System, available from Apple Computer Inc. of Cupertino, Calif., UNIX operating systems, Microsoft® Windows® operating systems, BSD operating systems, and the like. Other implementations are possible.

The elements of the computer system 700 are described in greater detail below. In particular, the network interface 716 provides communication between the computer system 700 and any of a wide range of networks, such as an Ethernet (e.g., IEEE 802.3) network, a backplane, etc. The mass storage 718 provides permanent storage for the data and programming instructions to perform the above-described processes and features implemented by the respective computing systems identified above, whereas the system memory 714 (e.g., DRAM) provides temporary storage for the data and programming instructions when executed by the processor 702. The I/O ports 720 may be one or more serial and/or parallel communication ports that provide communication between additional peripheral devices, which may be coupled to the computer system 700.

The computer system 700 may include a variety of system architectures, and various components of the computer system 700 may be rearranged. For example, the cache 704 may be on-chip with processor 702. Alternatively, the cache 704 and the processor 702 may be packed together as a “processor module”, with processor 702 being referred to as the “processor core”. Furthermore, certain embodiments of the invention may neither require nor include all of the above components. For example, peripheral devices coupled to the standard I/O bus 708 may couple to the high performance I/O bus 706. In addition, in some embodiments, only a single bus may exist, with the components of the computer system 700 being coupled to the single bus. Moreover, the computer system 700 may include additional components, such as additional processors, storage devices, or memories.

In general, the processes and features described herein may be implemented as part of an operating system or a specific application, component, program, object, module, or series of instructions referred to as “programs”. For example, one or more programs may be used to execute specific processes described herein. The programs typically comprise one or more instructions in various memory and storage devices in the computer system 700 that, when read and executed by one or more processors, cause the computer system 700 to perform operations to execute the processes and features described herein. The processes and features described herein may be implemented in software, firmware, hardware (e.g., an application specific integrated circuit), or any combination thereof.

In one implementation, the processes and features described herein are implemented as a series of executable modules run by the computer system 700, individually or collectively in a distributed computing environment. The foregoing modules may be realized by hardware, executable modules stored on a computer-readable medium (or machine-readable medium), or a combination of both. For example, the modules may comprise a plurality or series of instructions to be executed by a processor in a hardware system, such as the processor 702. Initially, the series of instructions may be stored on a storage device, such as the mass storage 718. However, the series of instructions can be stored on any suitable computer readable storage medium. Furthermore, the series of instructions need not be stored locally, and could be received from a remote storage device, such as a server on a network, via the network interface 716. The instructions are copied from the storage device, such as the mass storage 718, into the system memory 714 and then accessed and executed by the processor 702. In various implementations, a module or modules can be executed by a processor or multiple processors in one or multiple locations, such as multiple servers in a parallel processing environment.

Examples of computer-readable media include, but are not limited to, recordable type media such as volatile and non-volatile memory devices; solid state memories; floppy and other removable disks; hard disk drives; magnetic media; optical disks (e.g., Compact Disk Read-Only Memory (CD ROMS), Digital Versatile Disks (DVDs)); other similar non-transitory (or transitory), tangible (or non-tangible) storage medium; or any type of medium suitable for storing, encoding, or carrying a series of instructions for execution by the computer system 700 to perform any one or more of the processes and features described herein.

For purposes of explanation, numerous specific details are set forth in order to provide a thorough understanding of the description. It will be apparent, however, to one skilled in the art that embodiments of the technology can be practiced without these specific details. In some instances, modules, structures, processes, features, and devices are shown in block diagram form in order to avoid obscuring the description. In other instances, functional block diagrams and flow diagrams are shown to represent data and logic flows. The components of block diagrams and flow diagrams (e.g., modules, blocks, structures, devices, features, etc.) may be variously combined, separated, removed, reordered, and replaced in a manner other than as expressly described and depicted herein.

Reference in this specification to “one embodiment”, “an embodiment”, “other embodiments”, “one series of embodiments”, “some embodiments”, “various embodiments”, or the like means that a particular feature, design, structure, or characteristic described in connection with the embodiment is included in at least one embodiment of the present technology. The appearances of, for example, the phrase “in one embodiment” or “in an embodiment” in various places in the specification are not necessarily all referring to the same embodiment, nor are separate or alternative embodiments mutually exclusive of other embodiments. Moreover, whether or not there is express reference to an “embodiment” or the like, various features are described, which may be variously combined and included in some embodiments, but also variously omitted in other embodiments. Similarly, various features are described that may be preferences or requirements for some embodiments, but not other embodiments.

The language used herein has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

1. A computer-implemented method comprising:
determining, by a computing system, a portion of a media stream to be moderated based on a violation of a policy associated with at least one geographic region of a plurality of geographic regions, wherein the policy includes a first copyright restriction policy and a first community guideline policy associated with a first geographic region of the plurality of geographic regions and a second copyright restriction policy and a second community guideline policy associated with a second geographic region of the plurality of geographic regions, wherein the second geographic region is different than the first geographic region, and wherein the second copyright restriction policy and the second community guideline policy are different than the first copyright restriction policy and the first community guideline policy;
generating, by the computing system, a moderated segment of audio, a moderated segment of video, an unmoderated segment of audio, and an unmoderated segment of video based on the portion of the media stream;
generating, by the computing system, a log associated with the media stream, wherein the log includes the violation, a first timestamp associated with a start of the portion of the media stream, and a second timestamp associated with an end of the portion of the media stream;
determining, by the computing system, a first request associated with a first viewer for the portion of the media stream based on the first timestamp and the second timestamp;
providing, by the computing system, the moderated segment of audio and the moderated segment of video to the first viewer based on the log associated with the media stream and first viewer information associated with the first viewer, wherein the first viewer information indicates the first viewer is in the first geographic region associated with the first copyright restriction policy and the first community guideline policy;
determining, by the computing system, a second request associated with a second viewer for the portion of the media stream; and
providing, by the computing system, the moderated segment of audio and the unmoderated segment of video to the second viewer based on the log associated with the media stream and second viewer information associated with the second viewer, wherein the second viewer information indicates the second viewer is in the second geographic region associated with the second copyright restriction policy and the second community guideline policy.

2. The computer-implemented method of claim 1, further comprising:
generating, by the computing system, a procedure call based on the determining the portion of the media stream to be moderated, wherein the procedure call includes the first timestamp and the second timestamp associated with the portion of the media stream to be moderated.

3. The computer-implemented method of claim 2, wherein the procedure call further includes information relating to a policy violation associated with the portion of the media stream to be moderated.

4. The computer-implemented method of claim 3, wherein the providing the moderated segment of audio and the moderated segment of video to the first viewer and the providing the moderated segment of audio and the unmoderated segment of video to the second viewer is based on the information relating to the policy violation.

5. The computer-implemented method of claim 1, wherein the log includes a first indication that audio in the portion of the media stream violates the copyright restriction policy in only one of the first geographic region and the second geographic region and a second indication that the video in the portion of the media stream violates the community guideline policy in only one of the first geographic region and the second geographic region.

6. The computer-implemented method of claim 1, further comprising:
providing, by the computing system, a notification to the first viewer that indicates that the media stream is moderated based on the violation of the policy.

7. The computer-implemented method of claim 1, further comprising:
providing, by the computing system, a notification to a streamer associated with the media stream that indicates that the media stream is moderated.

8. The computer-implemented method of claim 1, wherein the moderated segment of audio includes at least one of: a muted segment of audio, a silenced segment of audio, or a garbled segment of audio, and wherein the moderated segment of video includes at least one of: a blanked segment of video, a frozen segment of video, or a blurred segment of video.

9. The computer-implemented method of claim 1, wherein the first viewer information includes at least one of: an age, a geographical region, or a membership status associated with the first viewer.

10. The computer-implemented method of claim 1, wherein the media stream is broadcasted live to viewers in real time or near real time, and
wherein the determination of the portion of the media stream to be moderated based on the violation of the policy is further based on a real time or near real time analysis of the media stream that is broadcasted live.

11. A system comprising:
at least one processor; and
a memory storing instructions that, when executed by the at least one processor, cause the system to perform a method comprising:
determining a portion of a media stream to be moderated based on a violation of a policy associated with at least one geographic region of a plurality of geographic regions wherein the policy includes a first copyright restriction policy and a first community guideline policy associated with a first geographic region of the plurality of geographic regions and a second copyright restriction policy and a second community guideline policy associated with a second geographic region of the plurality of geographic regions, wherein the second geographic region is different than the first geographic region, and wherein the second copyright restriction policy and the second community guideline policy are different than the first copyright restriction policy and the first community guideline policy;
generating a moderated segment of audio, a moderated segment of video, an unmoderated segment of audio, and an unmoderated segment of video based on the portion of the media stream;
generating a log associated with the media stream, wherein the log includes the violation, a first timestamp associated with a start of the portion of the media stream, and a second timestamp associated with an end of the portion of the media stream;
determining a first request associated with a first viewer for the portion of the media stream based on the first timestamp and the second timestamp;
providing the moderated segment of audio and the moderated segment of video to the first viewer based on the log associated with the media stream and first viewer information associated with the first viewer, wherein the first viewer information indicates the first viewer is in the first geographic region associated with the first copyright restriction policy and the first community guideline policy;
determining a second request associated with a second viewer for the portion of the media stream; and
providing the moderated segment of audio and the unmoderated segment of video to the second viewer based on the log associated with the media stream and second viewer information associated with the second viewer, wherein the second viewer information indicates the second viewer is in the second geographic region associated with the second copyright restriction policy and the second community guideline policy.

12. The system of claim 11, further comprising:
generating, by the computing system, a procedure call based on the determining the portion of the media stream to be moderated, wherein the procedure call includes the first timestamp and the second timestamp associated with the portion of the media stream to be moderated.

13. The system of claim 12, wherein the procedure call further includes information relating to a policy violation associated with the portion of the media stream to be moderated.

14. The system of claim 13, wherein the providing the moderated segment of audio and the moderated segment of video to the first viewer and the providing the moderated segment of audio and the unmoderated segment of video to the second viewer is based on the information relating to the policy violation.

15. The system of claim 11, wherein the moderated segment of audio includes at least one of: a muted segment of audio, a silenced segment of audio, or a garbled segment of audio, and wherein the moderated segment of video includes at least one of:
a blanked segment of video, a frozen segment of video, or a blurred segment of video.

16. A non-transitory computer-readable storage medium including instructions that, when executed by at least one processor of a computing system, cause the computing system to perform a method comprising:
determining a portion of a media stream to be moderated based on a violation of a policy associated with at least one geographic region of a plurality of geographic regions, wherein the policy includes a first copyright restriction policy and a first community guideline policy associated with a first geographic region of the plurality of geographic regions and a second copyright restriction policy and a second community guideline policy associated with a second geographic region of the plurality of geographic regions, wherein the second geographic region is different than the first geographic region, and wherein the second copyright restriction policy and the second community guideline policy are different than the first copyright restriction policy and the first community guideline policy;
generating a moderated segment of audio, a moderated segment of video, an unmoderated segment of audio, and an unmoderated segment of video based on the portion of the media stream;
generating a log associated with the media stream, wherein the log includes the violation, a first timestamp associated with a start of the portion of the media stream, and a second timestamp associated with an end of the portion of the media stream;
determining a first request associated with a first viewer for the portion of the media stream based on the first timestamp and the second timestamp;
providing the moderated segment of audio and the moderated segment of video to the first viewer based on the log associated with the media stream and first viewer information associated with the first viewer, wherein the first viewer information indicates whether the first viewers in the first geographic region associated with the first copyright restriction policy and the first community guideline policy;
determining a second request associated with a second viewer for the portion of the media stream; and
providing the moderated segment of audio and the unmoderated segment of video to the second viewer based on the log associated with the media stream and second viewer information associated with the second viewer, wherein the second viewer information indicates the second viewer is in the second geographic region associated with the second copyright restriction policy and the second community guideline policy.

17. The non-transitory computer-readable storage medium of claim 16, further comprising:
generating a procedure call based on the determining the portion of the media stream to be moderated, wherein the procedure call includes the first timestamp and the second timestamp associated with the portion of the media stream to be moderated.

18. The non-transitory computer-readable storage medium of claim 17, wherein the procedure call further includes information relating to a policy violation associated with the portion of the media stream to be moderated.

19. The non-transitory computer-readable storage medium of claim 18, wherein the providing the moderated segment of audio and the moderated segment of video to the first viewer and the providing the moderated segment of audio and the unmoderated segment of video to the second viewer is based on the information relating to the policy violation.

20. The non-transitory computer-readable storage medium of claim 16, wherein the moderated segment of audio includes at least one of: a muted segment of audio, a silenced segment of audio, or a garbled segment of audio, and wherein the moderated segment of video includes at least one of: a blanked segment of video, a frozen segment of video, or a blurred segment of video.
